(19) United States
(12) Patent Application Publication
(10) Pub. No.: US 2026/0061262 A1
(43) Pub. Date: Mar. 5, 2026

(54) GOLF CLUB WITH A FRICTION SURFACE CONTAINING DIAMONDS

(71) Applicant: EML CO., LTD., Suwon-si (KR)

(72) Inventors: Eun Soo PARK, Yongin-si (KR); Ju Ho LEE, Hwaseong-si (KR); Chang Woo JEON, Suwon-si (KR); Seok Hun KU, Seoul (KR)

(73) Assignee: EML CO., LTD., Suwon-si (KR)

(21) Appl. No.: 18/898,798

(22) Filed: Sep. 27, 2024

(30) Foreign Application Priority Data
Aug. 27, 2024 (KR) 10-2024-0114765

(51) Int. Cl. A63B 53/04; B33Y 80/00

(52) U.S. Cl. CPC A63B 53/0445; A63B 53/047; B33Y 80/00

(57) ABSTRACT

The purpose of the present invention is to form a coating layer so as to increase the frictional force of a golf club face and to provide durability to the above coating layer to ensure the longer performance life of a golf club. According to the above purpose, the present invention provides a coating layer in which diamond particles are laminated on a golf club face by 3D printing.

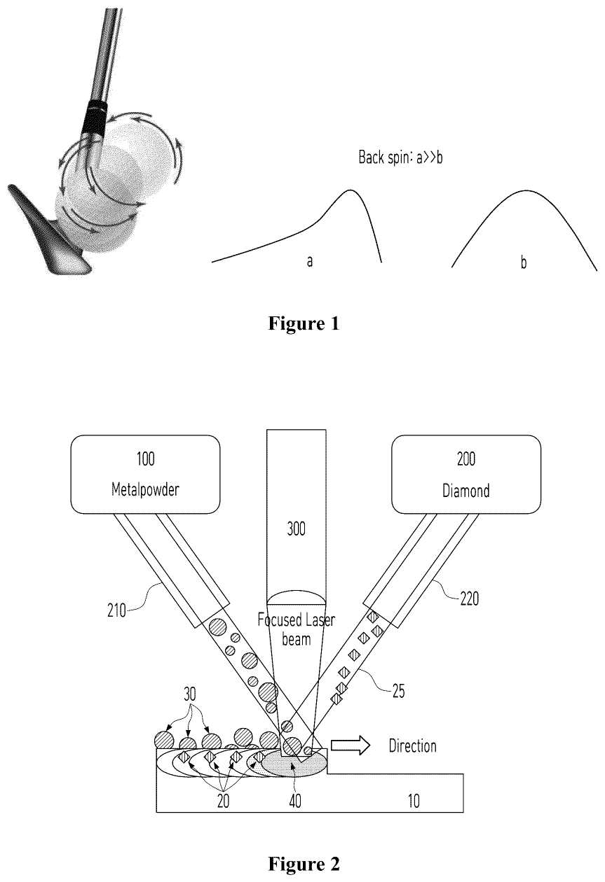

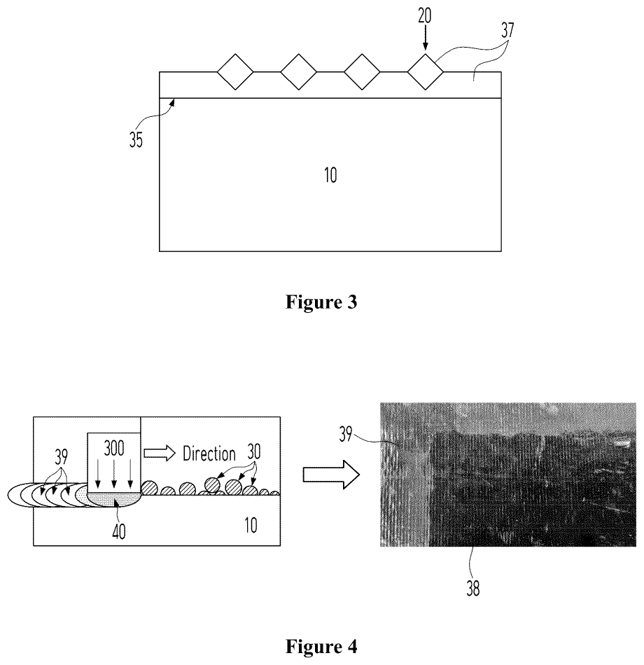

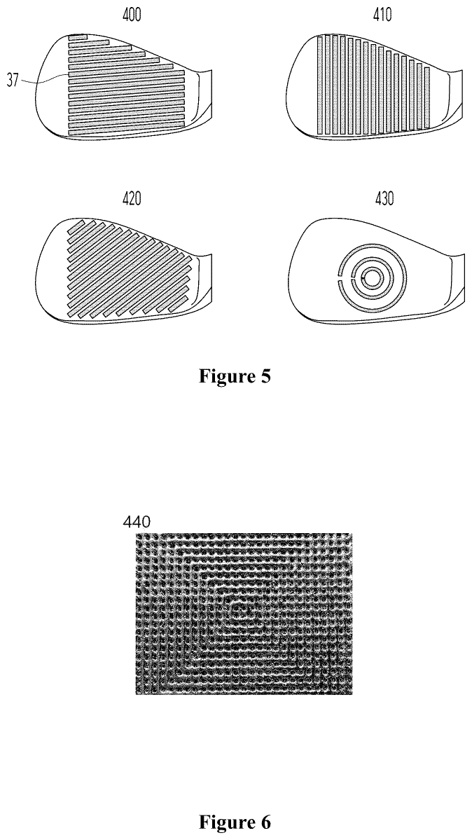

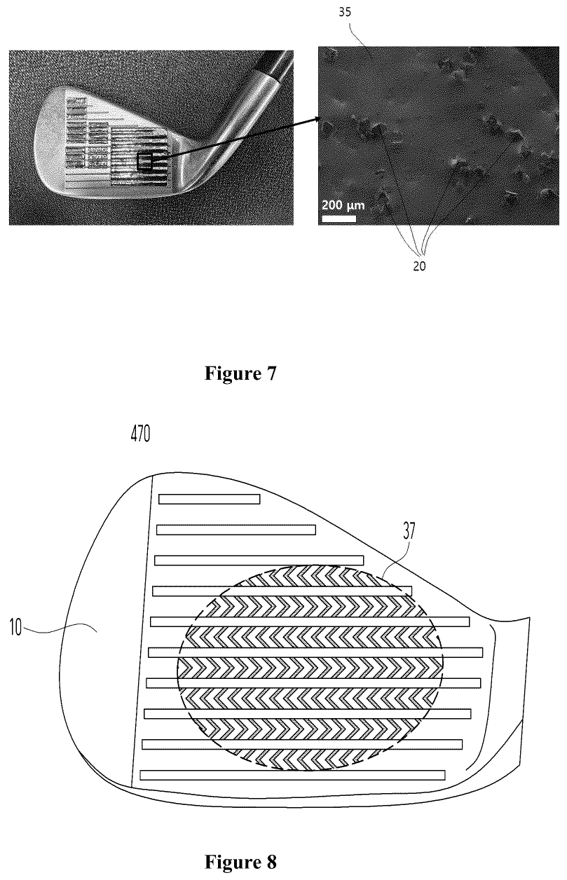

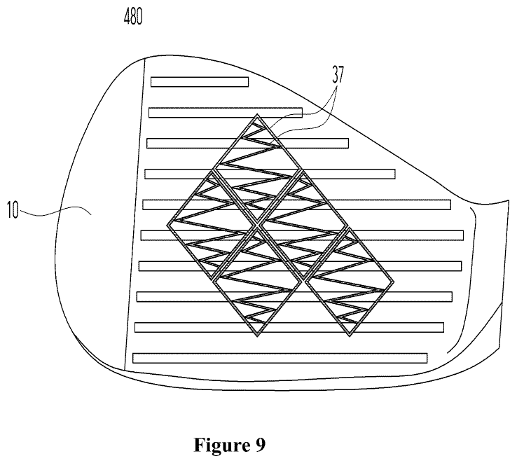

### CROSS-REFERENCE TO RELATED APPLICATIONS

This application claims the priority of Korean Patent Application No. 10-2024-0114765 filed on Aug. 27, 2024, in the Korean Intellectual Property Office, the disclosure of which is incorporated herein by reference.

### TECHNICAL FIELD

The present invention relates to a golf club, and more particularly, to a golf club with a friction surface containing diamonds.

### BACKGROUND OF THE INVENTION

In a golf game, the performance of a golf club affects the athletic performance just as much as the skill of the golfer. In particular, when hitting the ball with an iron or wedge, you may control the landing location of the ball by applying backspin to the ball or stop the ball at a desired point on the green or even put the ball in the hole through backward movement by backspin after landing. This backspin is affected especially by the angle at which the face of the golf club contacts the ball, that is, the lofting angle, and the size of the frictional force of the face of the golf club. In general, the larger the lofting angle and the greater the frictional force of the face, the greater the backspin. Therefore, a method for increasing the frictional force against the face of the golf club has been proposed. This application of frictional force to the face of the golf club requires durability of the friction surface due to the frictional force reduced as the golfer uses the golf club many times.

Generally, it is known that grooves are formed on the face of irons or wedges to strengthen frictional force and backspin, but experimental results show that they are unrelated to strengthening backspin. This is also related to the fact that the spin rate was reduced as a result of forming micro grooves on the face of a golf club in publicized patent No. 10-2024-0033184. In order to increase the frictional force of the face of a golf club, the above official report proposes a method of forming a puddle shape and configuring it with a different friction coefficient. However, this may be a problem because it is different from the standard shape of existing irons or wedges.

Korean Registered patent No. 10-2272809 provides durability by coating the surface of a golf club with an iron-based amorphous alloy. However, it is difficult to consider this technology as increasing friction.

### SUMMARY OF THE INVENTION

The purpose of the present invention is to form a coating layer so as to increase the frictional force of a golf club face and to provide durability to the above coating layer to ensure the longer performance life of a golf club.

According to the above purpose, the present invention provides a coating layer in which diamond particles are laminated on a golf club face by 3D printing. The diamond particles strengthen frictional force on the face of a golf club, provide durability with the ultra-high hardness unique to diamonds, and are 3D printed with a special pattern to provide even stronger frictional force against the golf ball rolling on the face.

### EFFECTS OF THE INVENTION

According to the present invention, the diamond particles strengthen frictional force on the face of a golf club, provide durability with the ultra-high hardness unique to diamonds, and are 3D printed with a special pattern to provide even stronger frictional force against the golf ball rolling on the face.

### BRIEF DESCRIPTION OF THE DRAWINGS

Drawing 1 is a diagram showing the trajectory of a golf ball according to the amount of backspin.

Drawing 2 is a schematic diagram roughly showing the process of laminating a diamond on a golf club face by 3D printing according to the present invention.

Drawing 3 is a cross-sectional diagram showing the configuration of a diamond embedding layer manufactured according to the present invention.

Drawing 4 is a schematic diagram describing laser polishing for a diamond embedding layer manufactured according to the present invention and a photog showing the process before and after laser polishing.

Drawing 5 are drawings describing the formation of a diamond embedding layer in various patterns on a golf club face according to the present invention.

Drawing 6 is a photo showing one embodiment of a pattern of a diamond embedding layer.

Drawing 7 is an SEM photo showing multiple patterns of diamond embedding layers fabricated on a small area of a single iron face and an enlarged view of the diamond embedding layer to confirm the presence of diamonds.

Drawing 8 is a drawing showing that the diamond embedding layer is formed in a zigzag pattern in the area corresponding to an ellipse on the golf club face.

Drawing 9 is a drawing showing a diamond embedding layer formed in a diamond-shaped area on a golf club face and in a zigzag pattern therein.

### DETAILED DESCRIPTION

With reference to the attached drawings, preferred embodiments of the present invention will be described in detail hereinafter.

Drawing 1 is a diagram showing the trajectory of a golf ball according to the amount of backspin. The trajectories of the ball are shown in contrast when the backspin is greater (a) and when it is less (b).

When a golfer hits the ball with an iron or wedge, if the amount of backspin is greater, the ball almost stops at the landing point. If the golfer adjusts the amount of backspin by adjusting the lofting angle of the golf club to control the strength of the backspin, the ball rolls backwards from the landing point and then stops. Therefore, a golfer can control the backspin to land the ball at the point he/she wants. The backspin of a golf ball highly depends on the lofting angle, which is the angle between the face of the golf club and the ground, and the size of the frictional force between the face and the ball. The larger the lofting angle and the greater the frictional force between the face and the ball, the greater the amount of backspin. Grooves that can increase frictional force are formed on the face of an iron and wedge. However, it is known that grooves do not significantly increase frictional force. Thus, attempts are often made to increase frictional force by milling or rusting the face. Milling processing and rust durability are poor, the frictional force enhancement effect is not enough, and the groove itself wears out, which shorten the frictional force enhancement life.

The present invention proposes a method for extending the life of a golf club by strengthening the frictional force of a golf club face and providing durability to the friction surface.

In other words, the present invention extends the life of a golf club by laminating micro diamonds on the golf club face by 3D printing to strengthen the frictional force of the face and utilize the durability unique to diamonds to strengthen the durability of the friction surface.

There are methods for attaching micro-diamonds to a substrate, such as sintering using metal powder, brazing, thermal spraying, or electrodeposition plating, but it is difficult to apply such methods to a golf club face, and it is almost impossible to fabricate a diamond-embedding layer in an appropriate pattern on a golf club face. However, micro-diamonds can be laminated on a golf club face in a desired pattern through metal 3D printing.

Drawing 2 is a schematic diagram roughly showing the process of laminating a diamond on a golf club face by 3D printing according to the present invention. In addition, drawing 3 shows the configuration of a diamond embedding layer manufactured accordingly.

A metal 3D printer using a laser melting method performs 3D printing by supplying metal powder through a nozzle and irradiating a laser on the metal powder to fuse the metal powder onto a substrate. In the present invention, metal powders (30) and micro-diamonds (20) are supplied to a golf club face (10) through the first nozzle (210) and the second nozzle (220) of a 3D printer, and a laser beam (300) is irradiated towards the supplied materials to form a melting pool (40) while the metal powder is fused, thereby fixing the diamonds (20) to the golf club face (10). The nozzles (210, 220) of the 3D printer and the laser beam (300) advance relative to the substrate, making a diamond deposition area progress. The face (10) may also be scanned with respect to the nozzle and the laser beam. Metal powder (30) and micro-diamonds (20) are simultaneously supplied to the face (10) together with shielding gas (25). The laser beam (300) fuses the metal powder (20) onto the face (10), so the micro-diamonds (20) are adhered to the face (10) and laminated along with the solidification of the metal. As shown above, the diamonds (20) laminated on the golf club face (10) are formed as a diamond embedding layer (37) whose sharp parts are exposed above the filler metal base layer (35). The exposed micro-diamond (20) part strengthens frictional force on the golf club face (10) and shows strong durability.

The thickness of the filler metal base layer (35) is formed to be about ½ to ⅔ of the size of the micro-diamond (20), and about ⅓ to ½ of the body of the micro-diamond (20) is exposed above the filler metal base layer (35), thereby strengthening frictional force and stably fixing it, which provides durability to the friction surface.

The material of the filler metal base layer (35) may be a Zr-based amorphous alloy, a Ni-based superalloy, or a Ti-based alloy. Also, these can achieve a brazing effect through 3D printing. In particular, a Ti-based alloy has excellent reactivity with diamond.

The size (diameter) of the metal powder is 30 to 150 μm, preferably 70 to 120 μm, while the size of the micro-diamond is 30 to 150 μm, preferably 70 to 120 μm.

The laser power should be set to 150 to 600 W, but it may be adjusted as follows depending on the material of the filler metal base layer (35). Zr-based amorphous alloys may be 150 to 300 W, Ni-based superalloys 300 to 500 W, and Ti-based alloys 300 to 500 W.

The scan speed of the club face and the nozzle (210, 220) and the laser beam (300) (which can also scan the golf club head) may be 400 to 1500 mm/min, preferably, 600 to 1200 mm/min for a Zr-based amorphous alloy, 600 to 1000 mm/min for a Ni-based superalloy, and 600 to 1000 mm/min for a Ti-based alloy.

Elements that can be contained in Zr-based amorphous alloys include Al, Cu, Ti, Ni, Ag, Nb, Mo, Be, Y, and Sn, and those that can be contained in Ti-based amorphous alloys include Al, Cu, Zr, Ni, Ag, Nb, Mo, Be, Y, and Sn.

A Zr-based amorphous alloy is designed to contain about 4.5 to 5.5 at % of at least one of the above-listed elements and 50 to 60 at % of Zr.

A specific alloy composition example is Zr₅₅Al₁₀Ni₅Cu₃₀ (at %).

The examples of Ni-based superalloys (wt. %) are as follows:
1) Composition of INCONEL718

Ni 50-55%, Cr: 17-21%, Iron (Fe): 17%, Niobium (Nb)+Tantalum (Ta): 4.75-5.50%, Molybdenum (Mo): 2.80-3.30%, Titanium (Ti): 0.65-1.15%, Aluminum (Al): 0.20-0.80%
2) Composition of INCONEL625 Nickel (Ni): 58% min., Chromium (Cr): 20.0-23.0%, Molybdenum (Mo): 8.0-10.0%, Niobium (Nb) +Tantalum (Ta): 3.15-4.15%, Iron (Fe): 5.0% max.
3) Composition of INCONEL939

Nickel (Ni): Balance, Chromium (Cr): 21.5-23.5%, Cobalt (Co): 18.0-20.0%, Titanium (Ti): 3.5-3.9%, Tantalum (Ta): 1.2-1.6%, Tungsten (W): 1.8-2.2% Ti-based alloy powder may contain Ti in an amount of 80 at. % or more, and elements that can be alloyed include Al, Ni, Co, Nb, Mo, Si, Cr, Sn, In, B, V, and Fe. The specific composition of the alloy is as follows:
Ti-based alloy (wt %)
1) Ti grade 2

Titanium (Ti): Balance (appr. 99.2%), Iron (Fe): ≤0.30%, Oxygen (O): ≤0.25%, Carbon (C): ≤0.08%, Nitrogen (N): ≤0.03%, Hydrogen (H): ≤0.015%
2) Ti grade 5
Titanium (Ti): Balance (appr. 87.725-91%), Aluminum (Al): 6%Vanadium (V): 4%, Iron (Fe): ≤0.40%, Oxygen (O): ≤0.20%, Carbon (C): ≤0.08% Ni-based alloys include Ti, Sn, Ag, Fe, and V. For reference, Ni-based superalloys are commercialized.

In the 3D printer, the supply speed of metal powder (30) through the first nozzle (210) may be set to 0.05 to 0.5 g/sec, while the supply speed of diamond (20) through the second nozzle (220) may be set to 0.005 to 0.1 g/sec. The second nozzle (220) supplies diamond together with shielding gas (25), and the shielding gas may be an inert gas such as argon (Ar) or nitrogen (N2).

In addition, a lamination method can be applied in which metal powder (30) and diamond (20) are mixed at a certain ratio and supplied through the first nozzle (210). In this case, the supply speed may be set to 0.005 to 0.5 g/sec.

In the 3D printing process, the metal powder and micro-diamonds supplied to the substrate are mostly oversupplied, causing residues left after fusing onto the substrate, and there are also powders that are not completely fused onto the substrate. These residues need to be removed, which is carried out by polishing. The present invention carries out polishing using the same 3D printer used for lamination without a separate polishing device. In other words, laser polishing is carried out by driving only a laser to irradiate the lamination section without supplying materials to the nozzle of the 3D printer.

As the laser is irradiated on the face where the metal and diamond (20) are fused and solidified, a melting pool (40) is instantly formed, and excess metal powder and incompletely fixed diamond particles are removed from the surface, and some are re-fused and solidified, being stably fixed to the face. Thus, the metal base surface becomes smooth and the micro-diamond (20) is stably fixed to the metal base.

Drawing 4 is a schematic diagram describing laser polishing for a diamond embedding layer manufactured according to the present invention and a photog showing the process before and after laser polishing.

The filler metal powder is a Zr-based amorphous alloy, the size of the filler metal powder is 70 to 120 μm, that of the diamond is 70 to 120 μm, and the laser power for laser polishing is 190 to 210 W, preferably 200 W, and the scan speed for polishing is 900 mm/min. to 1100 mm/min., preferably 1000 mm/min. On the right side of Drawing 4, there is a photo to distinguish the appearance of the diamond embedding layer before laser polishing (38) and the surface shape of the diamond embedding layer after laser polishing (39).

Drawing 5 are drawings describing the formation of a diamond embedding layer in various patterns on a golf club face according to the present invention.

In order to strengthen backspin on a golf ball, a diamond embedding layer (37) that can increase frictional force on a golf club face is 3D printed to form a pattern, thereby strengthening frictional force by the pattern and resistance by airflow. The diamond embedding layer (37) can be formed into horizontal stripes (400), vertical stripes (410), diagonal stripes (420), and concentric patterns (430). These patterns strengthen frictional force through additional frictional force by the pattern itself while using fewer diamonds than when diamonds (20) are uniformly distributed over the entire face. In Drawing 5, the patterns are distributed over the entire surface of the face.

Drawing 6 shows a diamond embedding layer (37) formed in a grid pattern.

The lines forming the grid include diamonds (20) to strengthen the frictional force, while the grid pattern itself like a checkered pattern strengthens the frictional force additionally. In this embodiment, the filler metal is made of a Zr-based amorphous alloy, the metal powder size is 70 to 120 μm, the diamond size is 70 to 120 μm, while the laser power of 3D printing is 200 W, and the scan speed is 1000 mm/min.

Drawing 7 is an SEM photo showing multiple patterns of diamond embedding layers fabricated on a small area of a single iron face and an enlarged view of the diamond embedding layer to confirm the presence of diamonds.

Drawing 7 shows diamond embedding layers formed in Zone 1 (500) corresponding to approximately half of the face area near the shaft side of an iron face, Zone 2 (510) adjacent to Zone 1 with a gap and corresponding to almost near the center of the face, Zone 3 (520) located above Zone 2, Zone 4 (530) located to the left of Zone 2 (510), Zone 5 (540) located above Zone 4, and Zone 6 (550) located above Zone 5. Each zone is arranged at a predetermined interval (2 mm to 10 mm), and Zone 1 (500) has an area approximately four times that of the other zones. The gap formed among Zone 1 (500), Zone 2 (510), and Zone 3 (520) forms a part like a road that vertically crosses almost the center of the face, and such a road part is formed among all the zones, making it possible to expect resistance due to air flow when hitting the ball. In particular, the road part formed in the center is a point where the ball is hit with a high probability, and Zones 1, 2 and 3 are arranged surrounding the part to strengthen frictional force. The lamination patterns of the diamond embedding layer of each zone may be the same or different, and they are different in the present embodiment. Zone 1 (500), Zone 3 (520), Zone 4 (530), and Zone 5 (540) form horizontal stripes, Zone 2 (510) forms a grid pattern, and Zone 6 (550) forms a vertical stripe pattern. The center of the face is a part where the ball hits easily, and the frictional force is strengthened by the vertical stripes, the grid pattern, and the road part formed among the three zones, which is advantageous for strengthening backspin. The vertical stripe pattern in Zone 6 (550) is useful for fabricating side spin. Each zone is represented as a square.

In Drawing 7, the filler metal laminated in the diamond-embedding layer includes Ti-based alloys, the size of the metal powder is 70 to 120 μm, the diamond size is 70 to 120 μm, the laser power is 400 W for the Ti-based alloys, and the scan speed is 800 mm/min.

Drawing 8 is a drawing that shows an oval zigzag pattern (470) formed in a zigzag pattern in the area corresponding to an ellipse extending from the center of the golf club face to the shaft side, in which the diamond embedding layer is formed in a zigzag pattern. The zigzag pattern is advantageous in increasing frictional force. In addition, the zigzag pattern is advantageous in strengthening backspin by including the center of the iron and the area close to the shaft side.

Drawing 9 shows a diamond embedding layer (37) formed in a diamond part (48) on a golf club face and a diamond part zigzag pattern (480) formed in a zigzag pattern therein.

4 diamond parts (480) are arranged radially symmetrically from the center of the iron, while the remaining one is arranged at a location tilted toward the shaft. 5 diamond parts (48) are formed at intervals from each other, and the diamond parts (48) have a zigzag pattern laminated on the edge and inside thereof by 3D printing. The intervals may be 3 to 10 mm. The arrangement itself of the diamond parts (48) strengthens frictional force, and the zigzag pattern inside further strengthens frictional force, which is advantageous for strengthening backspin.

The zigzag patterns in Drawings 8 and 9 are horizontal reciprocating patterns (left and right reciprocating) that prevent the golf ball from sliding down the iron and strengthen backspin.

In the above, irons were used as an example for the patterns and formation of the diamond embedding layer, but those can be applied to other golf clubs such as wedges.

Unless otherwise defined in the foregoing, all technical and scientific terms used in this specification have the same meaning as commonly understood by a skilled expert in the art to which the present invention pertains. In addition, terms defined in commonly used dictionaries should not be ideally or excessively interpreted, unless explicitly specifically defined. When a part of the entire specification is expressed as “include” or “have” a certain component, this does not exclude other components, but rather means that other components can be included, unless specifically stated otherwise. In addition, the singular may include the plural depending on the context.

Also in this specification, the terms “above ˜” or “on ˜” include cases where the object is directly placed on top of a target object, as well as cases where there is another part in between.

Also in this specification, the terms “on top of ˜, on ˜ or above˜” or “below ˜” or “under ˜” mean locating above or below the target part and do not necessarily mean locating above or below the direction of gravity.

Also in this specification, the terms “between ˜” or “among˜” include cases where there is a space between objects as well as cases where there is another part in between.

The rights of the present invention are not limited to the embodiments described above, but are defined by what is described in the claims, and it is obvious that a person with ordinary skill in the art to which the present invention pertains can make various modifications and adaptations within the scope of the rights described in the claims.

### DESCRIPTION OF THE NUMBERS

Club face (10)
Diamond (20)
Shielding gas (25)
Metal powder (30)
Melting pool (40)
First nozzle (210)
Second nozzle (220)
Laser beam (300)
Metal base layer (35)
Before polishing (38)
After polishing (39)
Horizontal stripes (400)
Vertical stripes (410)
Diagonal stripes (420)
Concentric pattern (430)
Oval zigzag pattern (470)
Diamond part (48)
Diamond zigzag pattern (480)
Zone 1 (500)
Zone 2 (510)
Zone 3 (520)
Zone 4 (530)
Zone 5 (540)
Zone 6 (550)

1. A golf club comprising a golf club face and a diamond embedding layer in which diamonds are laminated on the golf club face using 3D printing, and sharp points of the diamonds are exposed over a filler metal base layer, thereby increasing the frictional force of the golf club face.

2. The golf club according to claim 1, wherein the material of the filler metal base layer includes a Zr-based amorphous alloy, a Ni-based superalloy, or a Ti-based alloy to show a brazing effect on the diamond and the golf club face through 3D printing.

3. The golf club according to claim 1, characterized by the diameter of the metal powder forming the filler metal base layer of 30 to 150 μm, and the size of the diamond of 30 to 150 μm.

4. The golf club according to claim 3, characterized by the thickness of the filler metal base layer of ½ to ⅔ of the size of the diamond, and the body of the diamond with ⅓ to ½ exposed above the filler metal base layer.

5. The golf club according to claim 1, characterized by the diamond embedding layer that is formed to exhibit a pattern, and the pattern including a horizontal stripe pattern, a vertical stripe pattern, a diagonal stripe pattern, a concentric circle pattern, a grid pattern or a zigzag pattern.

6. The golf club according to claim 1, characterized by the diamond embedding layer that is formed in a number of distinct zones spaced apart from each other on the golf club face, and by patterns formed by each zone.

7. The golf club according to claim 6, characterized by the diamond embedding layer that is formed in Zone 1 formed near the shaft side, Zone 2 formed adjacent to Zone 1 with a gap and close to the center of the face, Zone 3 located above Zone 2, Zone 4 located to the left of Zone 2, Zone 5 located above Zone 4, and Zone 6 (550) located above Zone 5.

8. The golf club according to claim 7, characterized by each zone that is arranged with a gap of 2 mm to 10 mm, and Zone 1 that has a larger area than the other zones.

9. The golf club according to claim 8, characterized by each zone that is represented as a square, and the gap formed among Zone 1, Zone 2, and Zone 3 that is formed by a road part vertically crossing the center of the face, and a road part formed among all the zones, thereby strengthening the frictional force of the face and providing resistance due to air flow when hitting the ball.

10. The golf club according to claim 7, characterized by the laminating pattern of the diamond embedding layer in each zone, which are formed identically or differently from each other.

11. The golf club according to claim 10, characterized by Zone 1 (500), Zone 3 (520), Zone 4 (530) and Zone 5 (540) with horizontal stripes, and Zone 2 (510) with a grid pattern.

12. The golf club according to claim 6, characterized by the filler metal base layer of the diamond embedding layer that includes Ti-based alloys, the size of metal powder of 70 to 120 μm, and the diamond size of 70 to 120 μm.

13. The golf club according to claim 5, characterized by the diamond embedding layer which includes the center of the golf club face and is formed in a zigzag pattern in an oval-shaped area extending towards the shaft.

14. The golf club according to claim 6, characterized by the golf club face that comprises a diamond part formed of a diamond-shaped rim and the diamond embedding layer with zigzag pattern of diamond part including a zigzag pattern formed within the diamond part, four of the above diamond parts that are arranged radially symmetrically from the center of the golf club face, the remaining one that is arranged at a location biased towards the shaft, and five diamond parts that are formed with a gap from each other.

15. The golf club according to claim 13, characterized by the above zigzag pattern that reciprocates left and right along the horizontal direction of the golf club face.

16. The golf club according to claim 14, characterized by the above zigzag pattern that reciprocates left and right along the horizontal direction of the golf club face.
